(19) United States
(12) Patent Application Publication
(10) Pub. No.: US 2010/0135804 A1
(43) Pub. Date: Jun. 3, 2010

(54) WIND-POWERED GENERATOR

(76) Inventors: Angel Suarez Del Moral, Maono (Cantabria) (ES); Carlos Diez Ruiz, Reinosa (ES)

Correspondence Address: BEEM PATENT LAW FIRM, 53 W. JACKSON BLVD., SUITE 1352, CHICAGO, IL, 60604-3787, US

(21) Appl. No.: 12/514,264

(22) PCT Filed: Nov. 8, 2006
(86) PCT No.: PCT/ES2006/000615

§ 371 Date: Jun. 19, 2009

(51) Int. Cl. F03D 3/06

(52) U.S. Cl. 416/131

(57) ABSTRACT

A generator with arms forming the shape of a star and with each of them having an articulated blade capable of being fixed to the arm and being fastened temporarily to it by means of a voidable retaining element, which is moveable between a retaining position and a released position of the corresponding blade.

### PURPOSE OF THE INVENTION

This invention refers to a wind-powered generator.

### FIELD OF THE INVENTION

It is the manufacturing of devices for the use of renewable natural energy, particularly wind energy, and the substitution of the use of fossil fuels for generating electricity.

### BACKGROUND OF THE INVENTION

Electrical energy generators powered by the force of the wind and provided with propellers, most of them with horizontal axes are well known. In some cases, in models with vertical axes, the propeller arms are holders of jointed blades that automatically position themselves in order to use the wind's energy regardless from which direction the wind comes.

The Spanish utility Model no U9902530 and the patent EP1091118 of the same applicant, describe a perfected wind-powered generator of the type mentioned above whose rotor is comprised of a blade holder, on each of its arms, destined to receive the thrust of the wind and transmit it to the rotor's spin axis.

In most of the known generators, it is difficult to use all of the wind's force since the direction that the blades are facing cannot be adjusted fully to the direction of the moving air at all times, resulting in a relatively low performance in proportion to the size and design of the converting devices in question.

U.S. Pat. No. 5,844,323 also describes a wind-powered generator of the type formed by a machine that has a set of rolling propellers with a spin axis and which is supplied with jointed blades on the various arms and which are moveable in relation to them.

Occasionally, it might be desirable to lock the blades to the arms that hold them, in cases, for example, where one wants to stop the generator operation, to make sure it does not start or to modify its movement for certain reasons. But this is not practical in the versions known so far.

### BRIEF DESCRIPTION OF THE DESCRIPTION

This case deals with a vertical-axis wind-powered generator whose rotor is made up of two blades of parallel and horizontal planes and arms that are also parallel, between which is placed sets of jointed blades on their vertical axes. The blades can be turned around said axes following the wind direction and their tips pivot on the arms of the blades. These arms have blade-locking elements, when desired, and with them it is possible to make the blades remain fixed to the arms, or alternatively, they can move freely in relation to them.

In order to facilitate the explanation, some drawings accompany this description in which are shown, including but not limited to, a case of a perfected wind-power generator, according to the principles of the claims.

### BRIEF DESCRIPTION OF THE DRAWINGS

FIG. 1 shows, on the side view and ground plan, the rotor of a generator of the type described, with two blades between each pair of parallel arms and with the blade-retaining elements activated.

FIG. 2 shows, also in side view and ground plan, the rotor of the generator of FIG. 1 with its blade-retaining elements deactivated.

FIG. 3 shows a rotor of the new generator, seen on the ground plan and with four blades between each pair of parallel arms.

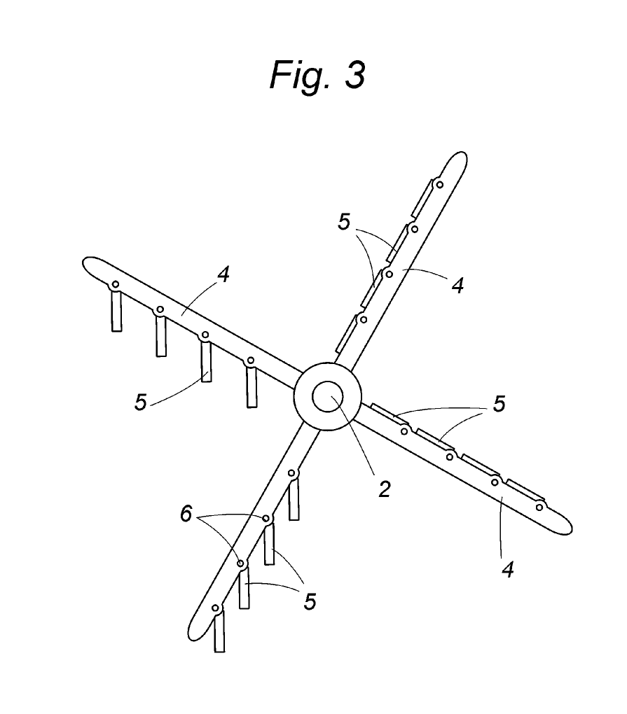

FIG. 4 is a view in perspective and of the entire new generator, in its version of FIG. 3, mounted on a support frame that facilitates its installation and, as a stator, permits the spinning of the device's rotor.

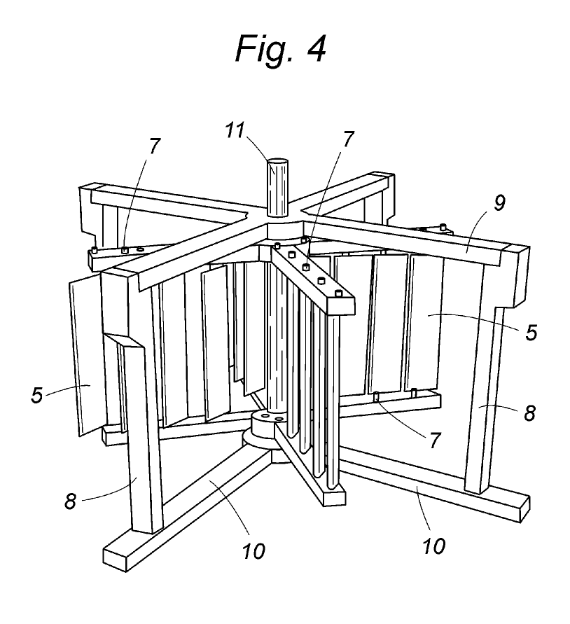

### DETAILED DESCRIPTION OF THE INVENTION

The designed elements with numbers in the drawing correspond to the parts indicated below.

Arrow 1 indicates the direction of the wind at a certain time, and 2 is the rotor axis of the generator, whose direction of spin is shown with arrow 3.

Each of the arms 4 of the rotor have two or more blades 5 mounted on them, which are articulated in the vertical spin axes 6 and adjustable with respect to said axes in any direction, depending on the wind.

The elements 7 are some stops or means to optionally retain the blades 5, consisting of on-demand activation pins capable of adopting at least two positions: one, projecting, in order to retain a blade in a given position, for example, in that of the arms 4; and another, withdrawn, to leave the blade in question free.

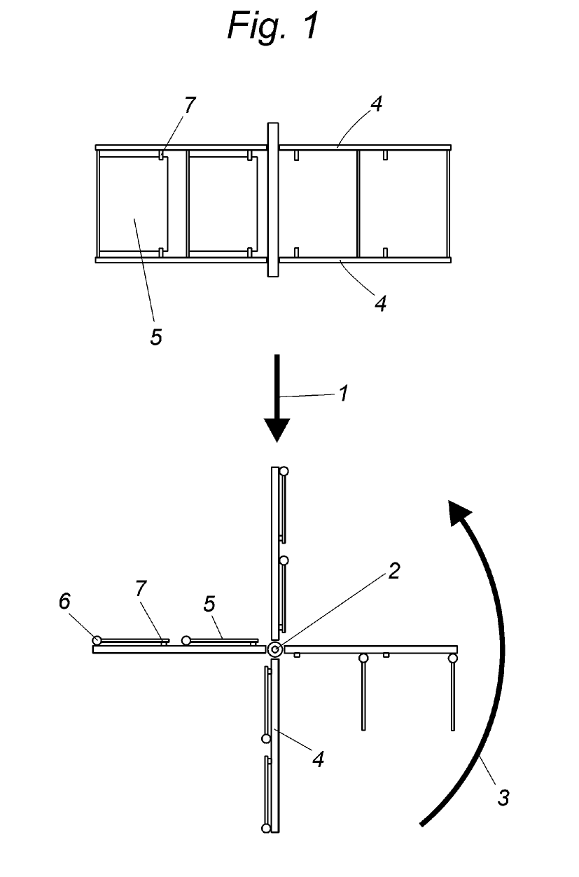

FIG. 1 shows the elements 7 activated, with which the blades 5 are retained and applied in parallel to the arms 4. The generator spins in the direction of arrow 3.

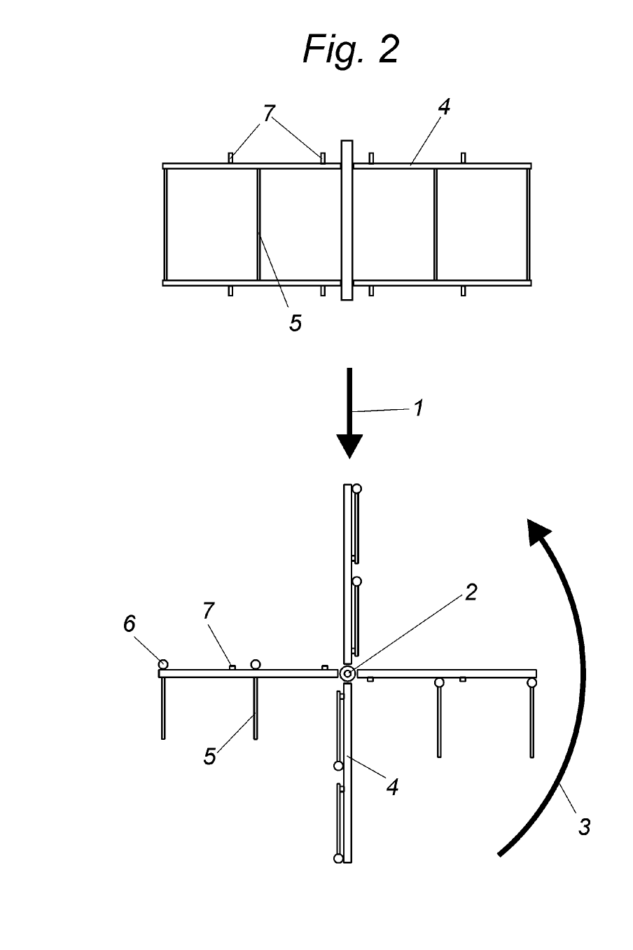

FIG. 2 shows with 7′ the elements 7 deactivated, leaving the blades 5′ free to spin with respect to the arms 2. By leaving the blades free, the wind-power generator is stopped, since, at the time considered, the blades associated to the arms are not operative since their direction coincides with that of the wind.

The described device permits, if desired, the generator not to start, which can be useful, for example, for machine maintenance purposes. If one wishes to stop the spin of the generator, the blade-retaining elements must be deactivated, with which the motor torque applied to them is cancelled, according to FIG. 2.

If what is of interest is the operation or start-up of a lesser motor torque, it is sufficient to deactivate the retaining elements corresponding to one or more blades of the arms, impeding the operation thereof.

The wind-power generator frame that is described consists basically of some vertical stands 8, holders of horizontal arms 9 forming a star in the upper part and supported on horizontal arms 10 in the lower part. The midpoints of both stars involve bearings for the spin of the ends of axis 2.

The head 11 of axis 2 or, alternatively, its base can serve for coupling a transducer (converter) in order to obtain electrical, mechanical or hydraulic energy aimed at diverse applications.

### DESIGN ASPECTS OF THE NEW GENERATOR

The concept of the generator that is described comes from the idea that the blades associated to the rotor blades have full freedom of movements, and, therefore, of turning around their vertical axes, depending on the direction, speed and intensity of the dominant wind.

The aforementioned design makes the use of a direction mechanism unnecessary, since it is automatic and inherent to the blades themselves. In fact, they situate themselves in order to exercise the maximum resistance to the wind when they are in the lead area of the generator and are aligned with the direction of the wind, practically without opposing any resistance to it.

Neither does the new machine require a support tower, essential in the horizontal axis generators and that can be omitted in the case of the new generator, which can be installed at nearly any height above the ground, since it can even take advantage of air currents that circulate at low levels.

The verticality of the spin axis of the rotor permits taking advantage of the direct force of the wind, and the practically nil resistance of return of the spinning blades, when they do not act, provides a very high coefficient of power, close to the theoretical limit imposed by the laws of physics, which is around 0.59 (Betz).

The power obtainable with the new wind-power generator is noticeably higher than that available in a conventional generator with a horizontal or vertical axis and of similar dimensions. With the new machine, considerable mechanical energy levels are obtained, which permits its adaptation to the propulsion of converters in other classes of energy: electrical, by means of generators of alternate or direct current, in the elevation or impulsion of liquids, etc.

1. Wind-powered generator, of the type that consists of a vertical spinning axis and formed by at least one functional end for the coupling of a device for the use of the generated mechanical energy, characterised by the axis (2) incorporating a pair of arms (4) of parallel and horizontal planes, whose arms, also parallel two by two, hold sets of rigid and articulated blades (5) with respect to their vertical axes (6) coinciding with one of the vertical sides of each plate, permitting its automatic situating according to the direction, speed and intensity of the wind.

2. Wind-powered generator, according to claim 1, characterised by each of the articulated blades (5), advantageously rectangular, which spin freely with respect to a vertical axis (6) incorporated and coinciding preferably with one of the vertical sides of the blade and has upper and lower retaining pins with the blade arms (4) having freedom to spin.

3. Wind-powered generator, according to claims 1 and 2, characterised by each one of the articulated blades (5) self-adjusts according to the direction of the wind, adopting positions with respect to the arms (4) of the blades that turn between 0 degrees and 90 degrees, corresponding to the parallel and perpendicular positions, respectively, of said direction.

4. Wind-powered generator, according to claims 1 to 3, characterised by the arms (4) of the rotor blades being provided with stopping and retaining elements (7) designed for the occasional immobilisation of the blades with respect to the arms (4) and capable of being activated and deactivated, as needed, for the released or retained positions of the blades.
